(19) United States
(12) Patent Application Publication
(10) Pub. No.: US 2023/0222917 A1
(43) Pub. Date: Jul. 13, 2023

(54) COMMUNICATION CONTROL DEVICE, CARAVAN TRAVEL CONTROL DEVICE, COMMUNICATION SYSTEM, AND COMMUNICATION CONTROL METHOD

(71) Applicant: Mitsubishi Electric Corporation, Tokyo (JP)

(72) Inventors: Masahiro NAKATSUKASA, Tokyo (JP); Akihiro SANADA, Tokyo (JP); Yoshihiro NAKAI, Kobe-shi, Hyogo (JP)

(73) Assignee: Mitsubishi Electric Corporation, Tokyo (JP)

(21) Appl. No.: 17/996,637

(22) PCT Filed: May 15, 2020
(86) PCT No.: PCT/JP2020/019370

§ 371 Date: Oct. 20, 2022

(51) Int. Cl. G08G 1/00; G08G 1/09; H04W 4/46

(52) U.S. Cl. CPC G08G 1/22; G08G 1/09; H04W 4/46

(57) ABSTRACT

A communication control device (5) includes: a vehicle information acquiring unit (41) to acquire vehicle information including communication performance information indicating performance of wireless communication in each of a plurality of vehicles (V); a data assignment unit (42) to assign individual pieces of data (D) included in a data group (DG) collected by a vehicle group (VG) to respective selected vehicles (V) among the plurality of vehicles (V) on the basis of the performance of the wireless communication; a data distribution unit (43) to execute control to distribute a piece of data (D) included in the data group (DG) to a corresponding one of the plurality of vehicles (V) by the wireless communication on the basis of a result of the assignment by the data assignment unit (42); and a transmission control unit (44) to execute control to transmit one of the pieces of data (D) which is assigned to a representative vehicle to a server (2) by the wireless communication.

### TECHNICAL FIELD

The present disclosure relates to a communication control device, a caravan travel control device, a communication system, and a communication control method.

### BACKGROUND ART

Conventionally, a system in which a vehicle group including a plurality of vehicles travels in a caravan by so-called “autonomous driving” or “remote driving” has been developed. That is, the plurality of vehicles include one leading vehicle, one or more intermediate vehicles, and one rearmost vehicle. Hereinafter, the intermediate vehicle and the rearmost vehicle may be collectively referred to as “following vehicles”. The following vehicle travels so as to follow the leading vehicle. As a result, caravan travel is achieved.

In addition, conventionally, a system that transmits data collected by a vehicle group traveling in a caravan to a server has been developed. The transmitted data is used for a predetermined purpose (hereinafter, sometimes referred to as an “application”). Specifically, for example, the transmitted data is used for remote driving or remote monitoring.

Here, Patent Literature 1 discloses a system in which a part of a plurality of vehicles (for example, a leading vehicle and a rearmost vehicle) transmits data to a server. In other words, the remaining vehicles (for example, intermediate vehicles) of the plurality of vehicles do not transmit data to the server. As a result, the total amount of data transmitted to the server is reduced as compared with a system in which each of a plurality of vehicles transmits data to the server.

### CITATION LIST

### Patent Literature

Patent Literature 1: JP 2019-175089 A

### SUMMARY OF INVENTION

### Technical Problem

Usually, performance of wireless communication in each individual vehicle varies due to various factors. For example, the communication speed (hereinafter, sometimes referred to as “throughput”) of the wireless communication in each individual vehicle varies depending on the level of the radio wave transmitted by the base station and varies depending on the number of reception terminals for the base station.

In the system described in Patent Literature 1, even when performance of wireless communication in the part of vehicles is low, the part of vehicles transmits data to the server. Therefore, for example, when the throughput of wireless communication in the part of vehicles is lower than the capacity required for data to be transmitted, there is a problem that a delay occurs in data transmission. As a result, there is a problem that the real-time property cannot be achieved when the transmitted data is used for an application having the real-time property (for example, remote driving or remote monitoring).

The present disclosure has been made to solve the above problems, and an object of the present disclosure is to implement data transmission depending on performance of wireless communication in each individual vehicle.

### Solution to Problem

A communication control device according to the present disclosure is a communication control device provided in a representative vehicle among a plurality of vehicles in a communication system in which the plurality of vehicles included in a vehicle group traveling in a caravan communicate freely with each other by wireless communication, and each of the plurality of vehicles communicates freely with a server by the wireless communication, the communication control device including: a vehicle information acquiring unit to acquire vehicle information including communication performance information indicating performance of the wireless communication in each of the plurality of vehicles; a data assignment unit to assign individual pieces of data included in a data group collected by the vehicle group to respective selected vehicles among the plurality of vehicles on the basis of the performance of the wireless communication; a data distribution unit to execute control to distribute a piece of data included in the data group to a corresponding one of the plurality of vehicles by the wireless communication on the basis of a result of the assignment by the data assignment unit; and a transmission control unit to execute control to transmit one of the pieces of data which is assigned to the representative vehicle to the server by the wireless communication.

### Advantageous Effects of Invention

According to the present disclosure, with the above configuration, data transmission depending on the performance of the wireless communication in each individual vehicle can be implemented.

### BRIEF DESCRIPTION OF DRAWINGS

FIG. 1 is a block diagram illustrating a main part of a communication system according to a first embodiment.

FIG. 2 is a block diagram illustrating a main part of a data collection device provided in each individual vehicle in the communication system according to the first embodiment.

FIG. 3 is a block diagram illustrating a hardware configuration of a main part of a wireless communication device provided in each individual vehicle in the communication system according to the first embodiment.

FIG. 4 is a block diagram illustrating the main part of the wireless communication device provided in each individual vehicle in the communication system according to the first embodiment.

FIG. 5 is a block diagram illustrating a main part of a communication control device provided in a leading vehicle in the communication system according to the first embodiment.

FIG. 6 is a block diagram illustrating a main part of a communication control device provided in each following vehicle in the communication system according to the first embodiment.

FIG. 7 is a block diagram illustrating a hardware configuration of the main part of the communication control device provided in each individual vehicle in the communication system according to the first embodiment.

FIG. 8 is a block diagram illustrating another hardware configuration of the main part of the communication control device provided in each individual vehicle in the communication system according to the first embodiment.

FIG. 9 is a block diagram illustrating another hardware configuration of the main part of the communication control device provided in each individual vehicle in the communication system according to the first embodiment.

FIG. 10 is a flowchart illustrating an operation of the communication control device provided in the leading vehicle in the communication system according to the first embodiment.

FIG. 11 is a flowchart illustrating an operation of the communication control device provided in each following vehicle in the communication system according to the first embodiment.

FIG. 12 is a flowchart illustrating an operation of a data assignment unit in the communication control device provided in the leading vehicle in the communication system according to the first embodiment.

FIG. 13 is a flowchart illustrating an operation of the data assignment unit in the communication control device provided in the leading vehicle in the communication system according to the first embodiment.

FIG. 14 is an explanatory diagram illustrating an example of a correspondence relationship between an application which uses a data group and priority assigned to each individual piece of data.

FIG. 15 is an explanatory diagram illustrating an example of a vehicle information table before update.

FIG. 16 is an explanatory diagram illustrating an example of an updated vehicle information table.

FIG. 17 is an explanatory diagram illustrating an example of assignment information.

FIG. 18A is an explanatory diagram illustrating an example of a data group to be transmitted to a server. FIG. 18B is an explanatory diagram illustrating an example of data assigned to individual vehicles.

FIG. 19 is a block diagram illustrating a main part of a communication system according to a second embodiment.

FIG. 20 is a block diagram illustrating a main part of a communication control device provided in a representative vehicle in the communication system according to the second embodiment.

FIG. 21 is a flowchart illustrating an operation of the communication control device provided in the representative vehicle in the communication system according to the second embodiment.

FIG. 22 is a flowchart illustrating an operation of a data assignment unit in the communication control device provided in the representative vehicle in the communication system according to the second embodiment.

FIG. 23A is an explanatory diagram illustrating an example of a data group to be transmitted to the server. FIG. 23B is an explanatory diagram illustrating an example of data assigned to individual vehicles.

FIG. 24 is a block diagram illustrating a main part of a communication system according to a third embodiment.

FIG. 25 is a block diagram illustrating a main part of a caravan travel control device in the communication system according to the third embodiment.

FIG. 26 is a block diagram illustrating a hardware configuration of the main part of the caravan travel control device in the communication system according to the third embodiment.

FIG. 27 is a block diagram illustrating another hardware configuration of the main part of the caravan travel control device in the communication system according to the third embodiment.

FIG. 28 is a block diagram illustrating another hardware configuration of the main part of the caravan travel control device in the communication system according to the third embodiment.

FIG. 29 is a flowchart illustrating an operation of the caravan travel control device in the communication system according to the third embodiment.

FIG. 30 is an explanatory diagram illustrating an example of a vehicle-to-vehicle communication throughput table before update.

FIG. 31 is an explanatory diagram illustrating an example of an updated vehicle-to-vehicle communication throughput table.

FIG. 32A is an explanatory diagram illustrating an example of a vehicle group before a vehicle order is changed. FIG. 32B is an explanatory diagram illustrating an example of the vehicle group after the vehicle order is changed.

FIG. 33 is a block diagram illustrating a main part of another caravan travel control device in the communication system according to the third embodiment.

### DESCRIPTION OF EMBODIMENTS

In order to explain this disclosure in more detail, modes for carrying out the present disclosure will be described below with reference to the accompanying drawings.

### First Embodiment

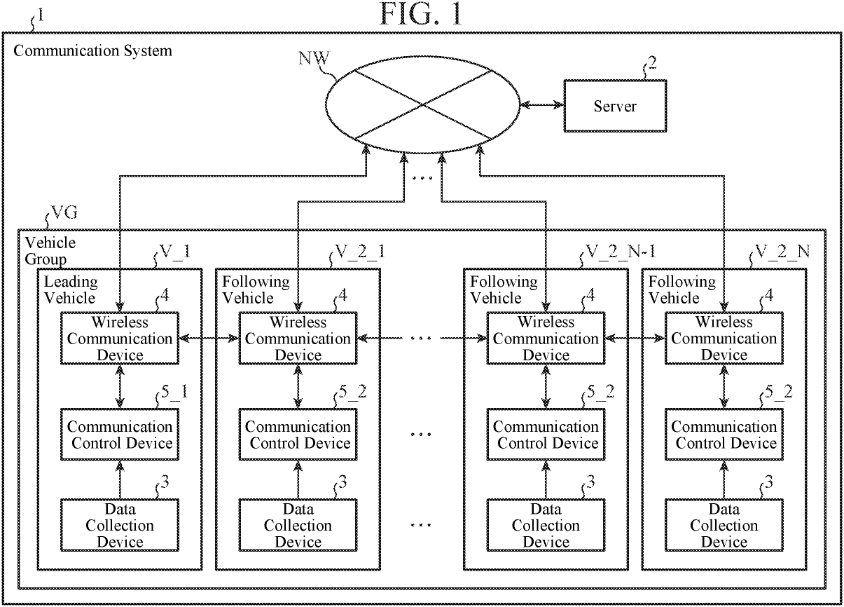

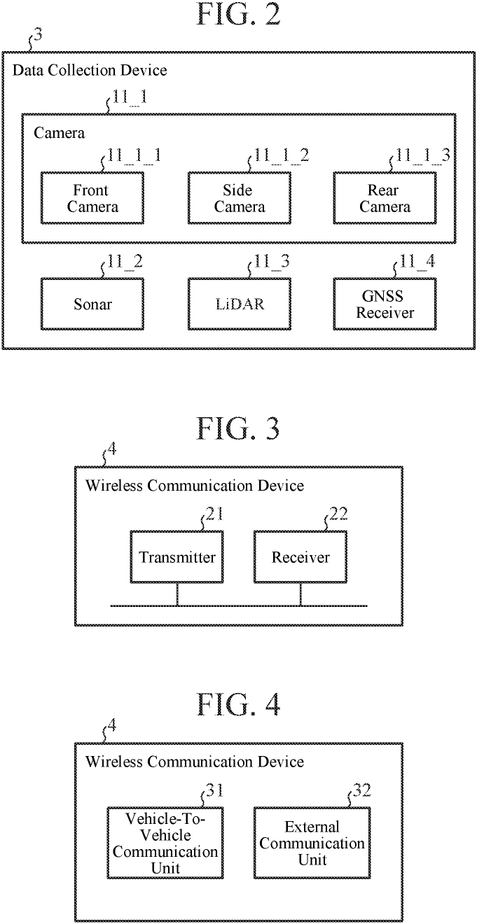

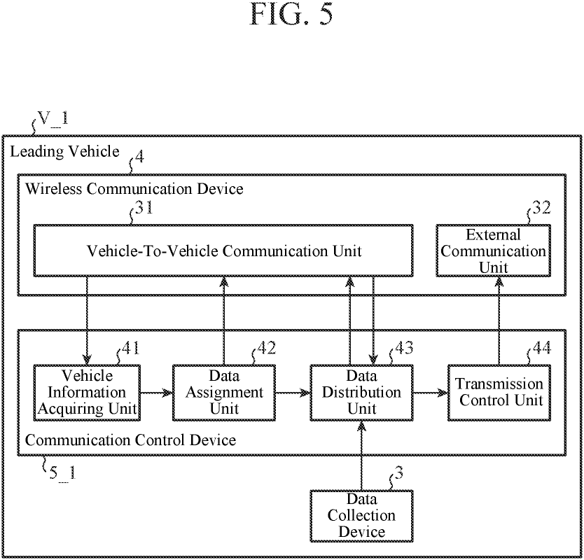

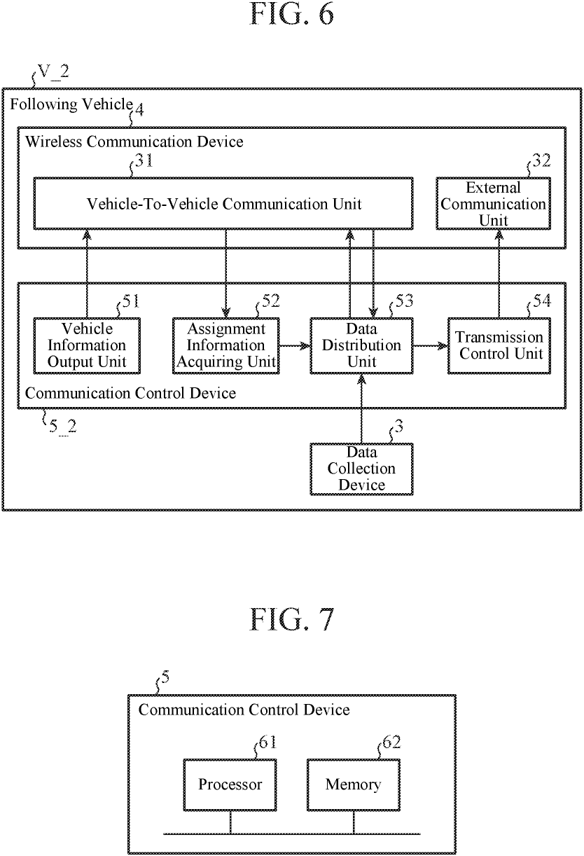

FIG. 1 is a block diagram illustrating a main part of a communication system according to a first embodiment. FIG. 2 is a block diagram illustrating a main part of a data collection device provided in each individual vehicle in the communication system according to the first embodiment. FIG. 3 is a block diagram illustrating a hardware configuration of a main part of a wireless communication device provided in each individual vehicle in the communication system according to the first embodiment. FIG. 4 is a block diagram illustrating the main part of the wireless communication device provided in each individual vehicle in the communication system according to the first embodiment. FIG. 5 is a block diagram illustrating a main part of a communication control device provided in a leading vehicle in the communication system according to the first embodiment. FIG. 6 is a block diagram illustrating a main part of a communication control device provided in each following vehicle in the communication system according to the first embodiment. The communication system according to the first embodiment will be described with reference to FIGS. 1 to 6.

As illustrated in FIG. 1, a communication system 1 includes a server 2 and a vehicle group VG. The vehicle group VG includes a plurality of vehicles V. More specifically, the vehicle group VG includes N + 1 vehicles V. The N + 1 vehicles V travel in a caravan by autonomous driving or remote driving. That is, the N + 1 vehicles V include one leading vehicle V_1 and N following vehicles V_2. The N following vehicles V_2 include N -1 intermediate vehicles V_2_1 to V_2_N -1 and one rearmost vehicle V_2_N. Here, N is any integer greater than or equal to 2.

The autonomous driving levels of the N + 1 vehicles V may be different from each other. For example, the autonomous driving level of the leading vehicle V_1 may be different from the autonomous driving level of each following vehicle V_2.

Hereinafter, the n-th vehicle V from the head among the N + 1 vehicles V may be referred to as an “n-th vehicle”. In addition, the position of the n-th vehicle in the vehicle group VG may be referred to as a “position n”. Here, n is an individual integer no fewer than 1 nor more than N + 1.

As illustrated in FIG. 1, a data collection device 3 is provided in each individual vehicle V. As illustrated in FIG. 2, the data collection device 3 includes a plurality of types of sensors 11. Specifically, for example, the plurality of types of sensors 11 include a camera 11_1, a sonar 11_2, a light detection and ranging (LiDAR) 11_3, and a global navigation satellite system (GNSS) receiver 11_4. The camera 11_1 includes a front camera 11_1_1, a side camera 11_1_2, and a rear camera 11_1_3.

In other words, the plurality of data collection devices 3 are provided in the respective plurality of vehicles V. A data group DG including various pieces of data D is collected by the plurality of data collection devices 3. That is, the data group DG including various pieces of data D is collected by the vehicle group VG.

Specifically, for example, data D_1_1 indicating an image (hereinafter, referred to as a “front camera image”) captured by the front camera 11_1_1 in an individual vehicle V is collected. In addition, data D_1_2 indicating an image (hereinafter, referred to as a “side camera image”) captured by the side camera 11_1_2 in an individual vehicle V is collected. In addition, data D_1_3 indicating an image (hereinafter, referred to as a “rear camera image”) captured by the rear camera 11_1_3 in an individual vehicle V is collected. In addition, data D_2 indicating information (hereinafter referred to as “sonar information”) acquired using the sonar 11_2 in an individual vehicle V is collected. In addition, data D_3 indicating information (hereinafter referred to as “LiDAR information”) acquired by using the LiDAR 11_3 in an individual vehicle V is collected.

As illustrated in FIG. 1, a wireless communication device 4 is provided in each individual vehicle V. As illustrated in FIG. 3, the wireless communication device 4 includes a transmitter 21 and a receiver 22. As illustrated in FIG. 4, the wireless communication device 4 includes a vehicle-to-vehicle communication unit 31 and an external communication unit 32.

Any two of the plurality of vehicles V communicate freely with each other by so-called “vehicle-to-vehicle communication”. The vehicle-to-vehicle communication unit 31 is a part corresponding to vehicle-to-vehicle communication. Here, the vehicle-to-vehicle communication may be via a roadside device. That is, the vehicle-to-vehicle communication may be implemented by so-called “road-to-vehicle communication”.

Each of the plurality of vehicles V communicates freely with the server 2 by so-called “external communication”. The external communication unit 32 is a part corresponding to external communication. The external communication is implemented by, for example, so-called “mobile data communication”. The mobile data communication is based on a contract with a telecommunication carrier (hereinafter referred to as “carrier”). That is, the external communication uses the Internet. In the figure, NW represents a network used for the external communication.

As illustrated in FIG. 1, a communication control device 5 is provided in each individual vehicle V. More specifically, a communication control device 5_1 is provided in the leading vehicle V_1, and a communication control device 5_2 is provided in each following vehicle V_2.

As illustrated in FIG. 5, the communication control device 5_1 includes a vehicle information acquiring unit 41, a data assignment unit 42, a data distribution unit 43, and a transmission control unit 44. As illustrated in FIG. 6, the communication control device 5_2 includes a vehicle information output unit 51, an assignment information acquiring unit 52, a data distribution unit 53, and a transmission control unit 54.

Hereinafter, in the description related to an individual communication control device 5, one vehicle V having the communication control device 5 among the N + 1 vehicles V may be referred to as a “host vehicle”. Furthermore, in the description related to the individual communication control device 5, N vehicles V excluding the host vehicle among the N + 1 vehicles V may be referred to as “different vehicles”.

The vehicle information output unit 51 acquires information regarding the host vehicle (V_2). The vehicle information output unit 51 outputs the acquired information. Here, the information output by the vehicle information output unit 51 includes information related to the sensor 11 in the host vehicle (V_2), information indicating the position of the host vehicle (V_2) in the vehicle group VG, and information indicating performance of wireless communication in the host vehicle (V_2). The performance of the wireless communication includes performance of vehicle-to-vehicle communication and performance of external communication. The output information is transmitted to the leading vehicle V_1 by vehicle-to-vehicle communication.

The vehicle information acquiring unit 41 acquires information regarding the host vehicle (V_1). Furthermore, the vehicle information acquiring unit 41 acquires information regarding individual different vehicles (V_2) by vehicle-to-vehicle communication. That is, the vehicle information acquiring unit 41 acquires information (hereinafter referred to as “vehicle information”) regarding an individual vehicle V. Here, the vehicle information includes information (hereinafter, referred to as “sensor information”) related to the sensor 11 in an individual vehicle V, information (hereinafter, referred to as “caravan position information”) indicating the position (hereinafter, may be referred to as “caravan position”) of an individual vehicle V in the vehicle group VG, and information (hereinafter, referred to as “communication performance information”) indicating the performance (including performance of vehicle-to-vehicle communication and performance of external communication) of wireless communication in an individual vehicle V.

The sensor information includes information indicating the type of the sensor 11 in an individual vehicle V. In addition, the sensor information includes information indicating the capacity required for the data D collected by the individual sensor 11 in an individual vehicle V. In addition, the sensor information includes information indicating a time (including a delay time due to image processing, a delay time due to codec, and the like) taken to process the data D collected by the individual sensor 11 in an individual vehicle V.

The caravan position information includes information indicating the order of an individual vehicle V in the vehicle group VG. For example, such information is acquired by using the camera 11_1 and the GNSS receiver 11_4 in each individual vehicle V.

The communication performance information includes information (hereinafter, referred to as “communication standard information”) indicating a communication standard of wireless communication in an individual vehicle V. That is, the communication standard information includes information indicating a communication standard of vehicle-to-vehicle communication and information indicating a communication standard of external communication. The communication standard of the external communication in an individual vehicle V is, for example, 3rd generation (3G), long term evolution (LTE), or 5th generation (5G).

Further, the communication performance information includes information (hereinafter, referred to as “throughput information”) indicating a throughput of wireless communication in an individual vehicle V. That is, the throughput information includes information indicating a throughput of vehicle-to-vehicle communication and information indicating a throughput of external communication. Such throughputs are measured using dedicated application software in each individual vehicle V, for example.

Further, the communication performance information includes information (hereinafter, referred to as “delay time information”) indicating a delay time of wireless communication in an individual vehicle V. That is, the delay time information includes information indicating a delay time of vehicle-to-vehicle communication and information indicating a delay time of external communication. Such delay times are calculated using dedicated application software in each individual vehicle V, for example.

That is, test data for transmission is transmitted in each individual vehicle V. At this time, the throughput is measured and the transmission time is measured. In addition, test data for reception is received in each individual vehicle V. At this time, the reception time is measured. The delay time is calculated on the basis of the measured transmission time and the measured reception time.

Further, the communication performance information includes information (hereinafter, referred to as “contract plan capacity information”) indicating a data communication capacity (hereinafter, referred to as “contract plan capacity”) in a data communication plan contracted with a carrier for external communication in an individual vehicle V.

In addition, the communication performance information includes information (hereinafter, referred to as “contract plan remaining capacity information”) indicating the remaining amount (hereinafter, referred to as “contract plan remaining capacity”) of the contract plan capacity for wireless communication in an individual vehicle V.

Note that the throughput information may be generated as follows. That is, a so-called “area map” is provided by each individual carrier. The area map indicates radio wave intensity for each area. Therefore, the throughput at a point a predetermined distance (for example, 10 kilometers) ahead of the current position of the vehicle group VG is predicted on the basis of the radio wave intensity in an area including the point by using the area map. The throughput information is generated on the basis of the predicted throughput.

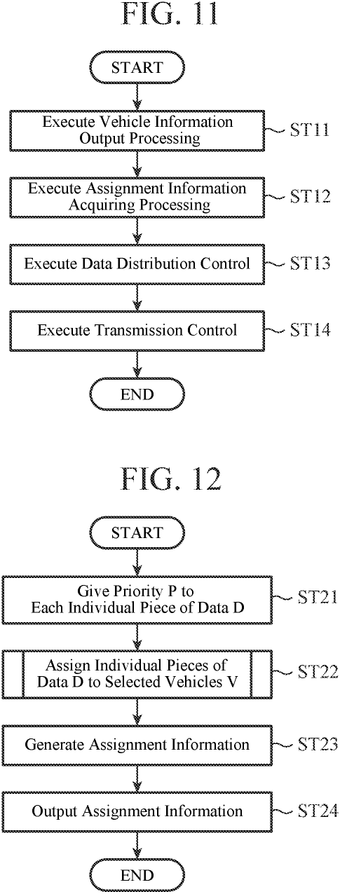

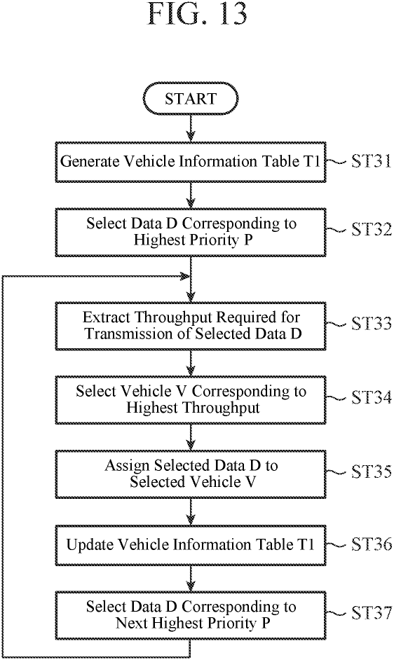

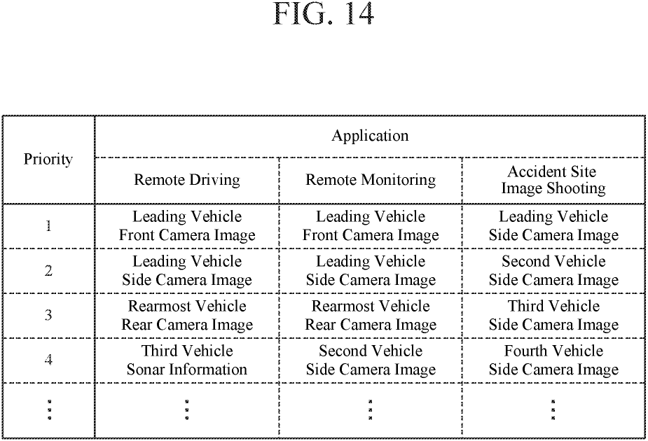

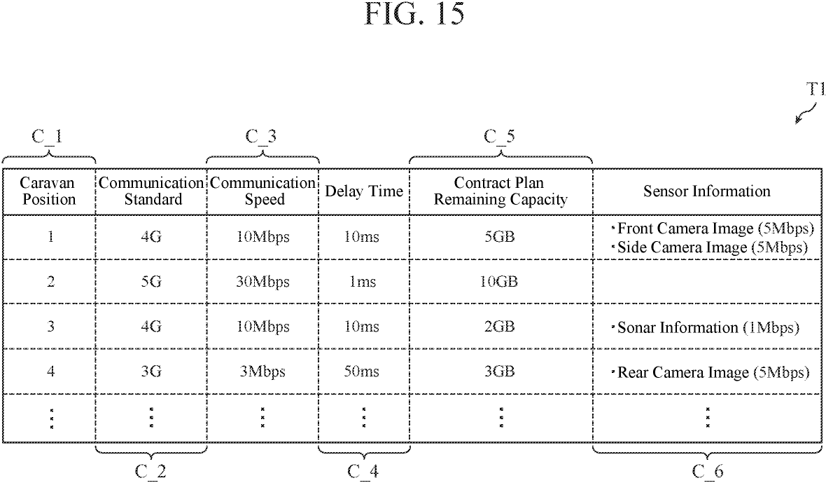

Using the vehicle information acquired by the vehicle information acquiring unit 41, the data assignment unit 42 assigns an individual piece of data D included in the data group DG to a selected vehicle V among the plurality of vehicles V. A specific example of the assignment by the data assignment unit 42 will be described later with reference to FIGS. 12 to 18. The data assignment unit 42 outputs information (hereinafter, referred to as “assignment information”) indicating a result of the assignment. The output assignment information is transmitted to each following vehicle V_2 by vehicle-to-vehicle communication.

The data distribution unit 43 acquires the assignment information output by the data assignment unit 42. In addition, the assignment information acquiring unit 52 acquires the transmitted assignment information by vehicle-to-vehicle communication. The data distribution units 43 and 53 distribute the data D included in the data group DG to the plurality of vehicles V using the acquired assignment information. That is, the data distribution units 43 and 53 distribute the data D included in the data group DG to the plurality of vehicles V by vehicle-to-vehicle communication on the basis of the result of the assignment by the data assignment unit 42.

More specifically, the data distribution unit 43 acquires a part of the data D assigned to the host vehicle (V_1) among the data D collected by the host vehicle (V_1). In addition, the data distribution unit 43 executes control to transmit a part of the data D assigned to an individual different vehicle (V_2) among the data D collected by the host vehicle (V_1) to the corresponding different vehicle (V_2) by vehicle-to-vehicle communication. In addition, the data distribution unit 43 executes control to receive a part of the data D assigned to the host vehicle (V_1) among the data D collected by an individual different vehicle (V_2) from the corresponding different vehicle (V_2) by vehicle-to-vehicle communication.

Similarly, the data distribution unit 53 acquires a part of the data D assigned to the host vehicle (V_2) among the data D collected by the host vehicle (V_2). In addition, the data distribution unit 53 executes control to transmit a part of the data D assigned to an individual different vehicle (V_1 or V_2) among the data D collected by the host vehicle (V_2) to the corresponding different vehicle (V_1 or V_2) by vehicle-to-vehicle communication. In addition, the data distribution unit 53 executes control to receive a part of the data D assigned to the host vehicle (V_2) among the data D collected by an individual different vehicle (V_1 or V_2) from the corresponding different vehicle (V_1 or V_2) by vehicle-to-vehicle communication.

As a result, to each of the vehicles V, data D to be transmitted to the server 2 by the host vehicle (V_1 or V_2) is distributed.

The transmission control unit 44 executes control to transmit the data D distributed to the host vehicle (V_1) to the server 2 by external communication. In other words, the transmission control unit 44 executes control to transmit the data D assigned to the host vehicle (V_1) to the server 2 by external communication.

The transmission control unit 54 executes control to transmit the data D distributed to the host vehicle (V_2) to the server 2 by external communication. In other words, the transmission control unit 54 executes control to transmit the data D assigned to the host vehicle (V_2) to the server 2 by external communication.

In this manner, the data group DG collected by the vehicle group VG is transmitted to the server 2. The transmitted data group DG is used for a predetermined application. Specifically, for example, the transmitted data group DG is used for remote driving, remote monitoring, or accident site image shooting.

Hereinafter, the processing executed by the vehicle information output unit 51 may be collectively referred to as “vehicle information output processing”. In addition, the processing executed by the vehicle information acquiring unit 41 may be collectively referred to as “vehicle information acquiring processing”. In addition, the processing executed by the data assignment unit 42 may be collectively referred to as “data assignment processing”. In addition, the processing executed by the assignment information acquiring unit 52 may be collectively referred to as “assignment information acquiring processing”. Furthermore, the processing and control executed by the data distribution unit 43 or the data distribution unit 53 may be collectively referred to as “data distribution control”. Furthermore, the processing and control executed by the transmission control unit 44 or the transmission control unit 54 may be collectively referred to as “transmission control”.

Hereinafter, the functions of the vehicle information output unit 51 may be collectively referred to as a “vehicle information output function”. In addition, the functions of the vehicle information acquiring unit 41 may be collectively referred to as a “vehicle information acquiring function”. In addition, the functions of the data assignment unit 42 may be collectively referred to as a “data assignment function”. In addition, the functions of the assignment information acquiring unit 52 may be collectively referred to as an “assignment information acquiring function”. Furthermore, the functions of the data distribution unit 43 or the data distribution unit 53 may be collectively referred to as a “data distribution function”. Furthermore, the functions of the transmission control unit 44 or the transmission control unit 54 may be collectively referred to as a “transmission function”.

Hereinafter, a reference sign “F1” may be used for the vehicle information output function or the vehicle information acquiring function. In addition, a reference sign “F2” may be used for the data assignment function or the assignment information acquiring function. In addition, a reference sign “F3” may be used for the data distribution function. In addition, a reference sign “F4” may be used for the transmission function.

Next, a hardware configuration of a main part of the communication control device 5 will be described with reference to FIGS. 7 to 9.

As illustrated in FIG. 7, the communication control device 5 includes a processor 61 and a memory 62. The memory 62 stores programs corresponding to a plurality of functions (including the vehicle information acquiring function, the data assignment function, the data distribution function, and the transmission function, or including the vehicle information output function, the assignment information acquiring function, the data distribution function, and the transmission function) F1 to F4. The processor 61 reads and executes the programs stored in the memory 62. As a result, the plurality of functions F1 to F4 are implemented.

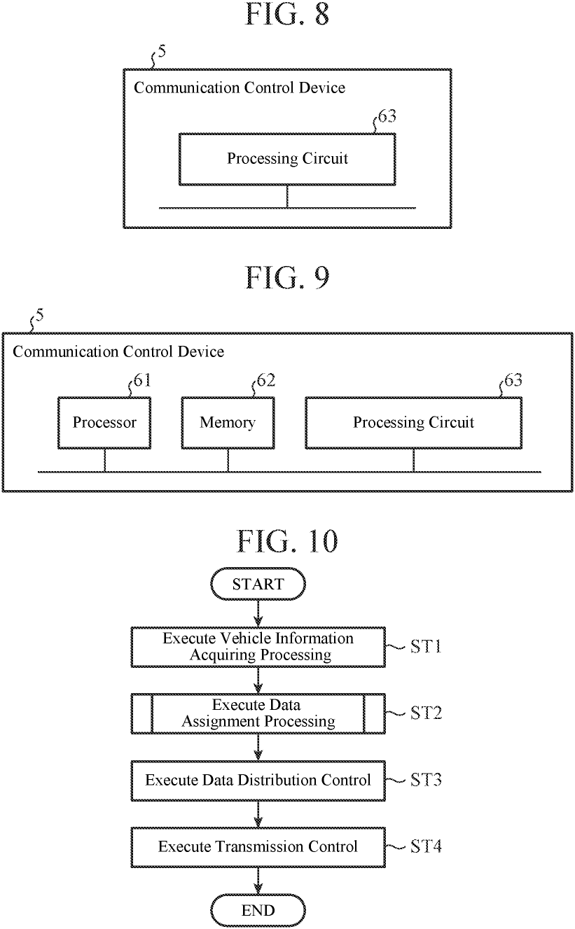

Alternatively, as illustrated in FIG. 8, the communication control device 5 includes a processing circuit 63. The processing circuit 63 executes processing corresponding to the plurality of functions F1 to F4. As a result, the plurality of functions F1 to F4 are implemented.

Alternatively, as illustrated in FIG. 9, the communication control device 5 includes a processor 61, a memory 62, and a processing circuit 63. The memory 62 stores programs corresponding to some of the functions F1 to F4. The processor 61 reads and executes the programs stored in the memory 62. As a result, some of the functions are implemented. In addition, the processing circuit 63 executes processing corresponding to the remaining functions among the plurality of functions F1 to F4. As a result, the remaining functions are implemented.

The processor 61 includes one or more processors. Each of the processors uses, for example, a central processing unit (CPU), a graphics processing unit (GPU), a microprocessor, a microcontroller, or a digital signal processor (DSP).

The memory 62 includes one or more nonvolatile memories. Alternatively, the memory 62 includes one or more nonvolatile memories and one or more volatile memories. That is, the memory 62 includes one or more memories. Each of the memories uses, for example, a semiconductor memory or a magnetic disk. More specifically, each of the volatile memories uses, for example, a Random Access Memory (RAM). In addition, each of the nonvolatile memories uses, for example, a Read Only Memory (ROM), a flash memory, an Erasable Programmable Read Only Memory (EPROM), an Electrically Erasable Programmable Read Only Memory (EEPROM), a solid state drive, or a hard disk drive.

The processing circuit 63 includes one or more digital circuits. Alternatively, the processing circuit 63 includes one or more digital circuits and one or more analog circuits. That is, the processing circuit 63 includes one or more processing circuits. Each of the processing circuits uses, for example, an Application Specific Integrated Circuit (ASIC), a Programmable Logic Device (PLD), a Field Programmable Gate Array (FPGA), a System on a Chip (SoC), or a system Large Scale Integration (LSI).

Here, when the processor 61 includes a plurality of processors, the correspondence relationship between the plurality of functions F1 to F4 and the plurality of processors can be determined freely. That is, each of the plurality of processors may read and execute programs corresponding to one or more corresponding functions among the plurality of functions F1 to F4. The processor 61 may include a dedicated processor corresponding to each of the plurality of functions F1 to F4.

When the memory 62 includes a plurality of memories, the correspondence relationship between the plurality of functions F1 to F4 and the plurality of memories can be determined freely. That is, each of the plurality of memories may store a program corresponding to one or more corresponding functions among the plurality of functions F1 to F4. The memory 62 may include a dedicated memory corresponding to each of the plurality of functions F1 to F4.

In addition, when the processing circuit 63 includes a plurality of processing circuits, the correspondence relationship between the plurality of functions F1 to F4 and the plurality of processing circuits can be determined freely. That is, each of the plurality of processing circuits may execute processing corresponding to one or more corresponding functions among the plurality of functions F1 to F4. The processing circuit 63 may include a dedicated processing circuit corresponding to each of the plurality of functions F1 to F4.

Next, the operation of the communication control device 5_1 will be described with reference to a flowchart illustrated in FIG. 10.

First, the vehicle information acquiring unit 41 executes vehicle information acquiring processing (step ST1). Next, the data assignment unit 42 executes data assignment processing (step ST2). Next, the data distribution unit 43 executes data distribution control (step ST3). Next, the transmission control unit 44 executes transmission control (step ST4).

Next, the operation of the communication control device 5_2 will be described with reference to a flowchart illustrated in FIG. 11.

First, the vehicle information output unit 51 executes vehicle information output processing (step ST11). Note that the vehicle information output processing may be executed in response to an execution request by the vehicle information acquiring unit 41. Next, the assignment information acquiring unit 52 executes assignment information acquiring processing (step ST12). Next, the data distribution unit 53 executes data distribution control (step ST13). Next, the transmission control unit 54 executes transmission control (step ST14).

Next, a specific example of assignment by the data assignment unit 42 will be described with reference to FIGS. 12 to 18. That is, a specific example of the data assignment processing will be described.

As illustrated in FIG. 12, first, the data assignment unit 42 gives a priority P to each individual piece of data D included in the data group DG (step ST21). At this time, the data assignment unit 42 gives a priority P which varies depending on the application which uses the data group DG, to each individual piece of data D.

That is, in the communication system 1, the priority P given to the individual piece of data D is set in advance for each application which uses the data group DG. FIG. 14 illustrates an example of a correspondence relationship between the application which uses the data group DG and the priority P given to the individual piece of data D. The data assignment unit 42 gives the priority P corresponding to the application which uses the data group DG to the individual piece of data D on the basis of the correspondence relationship.

Notification of the application which uses the data group DG may be provided to the leading vehicle V_1 by the server 2. In other words, the priority P given to the individual piece of data D may be changed by the server 2.

Next, the data assignment unit 42 assigns the individual pieces of data D included in the data group DG to selected vehicles V among the plurality of vehicles V (step ST22). Specifically, for example, the data assignment unit 42 assigns the data D to the vehicle V as follows.

First, the data assignment unit 42 generates a table (hereinafter, referred to as a “vehicle information table”) T1 based on the acquired vehicle information by using the vehicle information acquired by the vehicle information acquiring unit 41 (step ST31). FIG. 15 illustrates an example of the vehicle information table T1.

As illustrated in FIG. 15, the vehicle information table T1 includes rows corresponding to the individual vehicles V and includes columns C corresponding to individual pieces of information. In other words, the vehicle information table T1 includes a plurality of cells arranged in two directions. Each cell corresponds to one of the vehicles V and corresponds to one of the pieces of information.

In the example illustrated in FIG. 15, the vehicle information table T1 includes the following columns C_1 to C_6. That is, the column C_1 corresponds to the caravan position information. The column C_2 corresponds to the communication standard information (more specifically, information indicating the communication standard of the external communication). The column C_3 corresponds to the throughput information (more specifically, information indicating the throughput of the external communication). The column C_4 corresponds to the delay time information (more specifically, information indicating the delay time of the external communication). The column C_5 corresponds to the contract plan remaining capacity information. The column C_6 corresponds to the sensor information.

Next, the data assignment unit 42 selects the data D corresponding to the highest priority P among the data D included in the data group DG on the basis of the priorities P given to the individual pieces of data D (step ST32).

Next, the data assignment unit 42 extracts a throughput required for transmission of the selected data D using the vehicle information table T1 (step ST33).

Next, the data assignment unit 42 selects the vehicle V corresponding to the highest throughput using the vehicle information table T1 (step ST34). Normally, the vehicle V corresponding to the latest communication standard is selected.

At this time, when there are a plurality of vehicles V corresponding to the highest throughput, the data assignment unit 42 selects a vehicle V corresponding to a shorter delay time among the plurality of vehicles V on the basis of the vehicle information table T1. In addition, at this time, the data assignment unit 42 excludes the vehicle V corresponding to the contract plan remaining capacity less than a predetermined threshold from the selection target.

Next, the data assignment unit 42 assigns the selected data D to the selected vehicle V (step ST35).

Next, the data assignment unit 42 updates the vehicle information table T1 by subtracting the value of the throughput extracted in step ST33 from the value of the throughput corresponding to the vehicle V selected in step ST34 (step ST36). FIG. 16 illustrates an example of the updated vehicle information table T1.

Next, the data assignment unit 42 selects data D corresponding to the next highest priority P (step ST37). The data assignment unit 42 executes the processing in and after step ST33 for the selected data D using the updated vehicle information table T1.

Then, the processing of steps ST33 to ST37 is repeatedly executed. As a result, each individual piece of data D is assigned to a corresponding one of the vehicles V. The number of repetitions varies depending on the number of pieces of data D included in the data group DG to be transmitted to the server 2.

Next, the data assignment unit 42 generates assignment information on the basis of a result of the assignment (step ST23). Next, the data assignment unit 42 outputs the generated assignment information (step ST24).

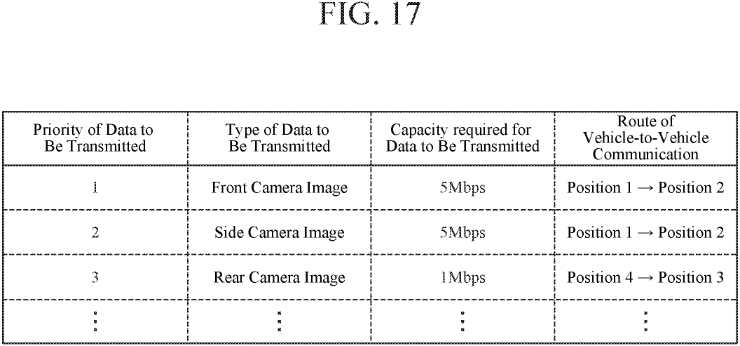

FIG. 17 illustrates an example of the assignment information. As illustrated in FIG. 17, the assignment information may include information indicating the priority P given to each individual piece of data D. Further, the assignment information may include information indicating the type of each individual piece of data D. Further, the assignment information may include information indicating the capacity required for each individual piece of data D. Further, the assignment information may include information indicating a route of the vehicle-to-vehicle communication in the data distribution control for each individual piece of data D.

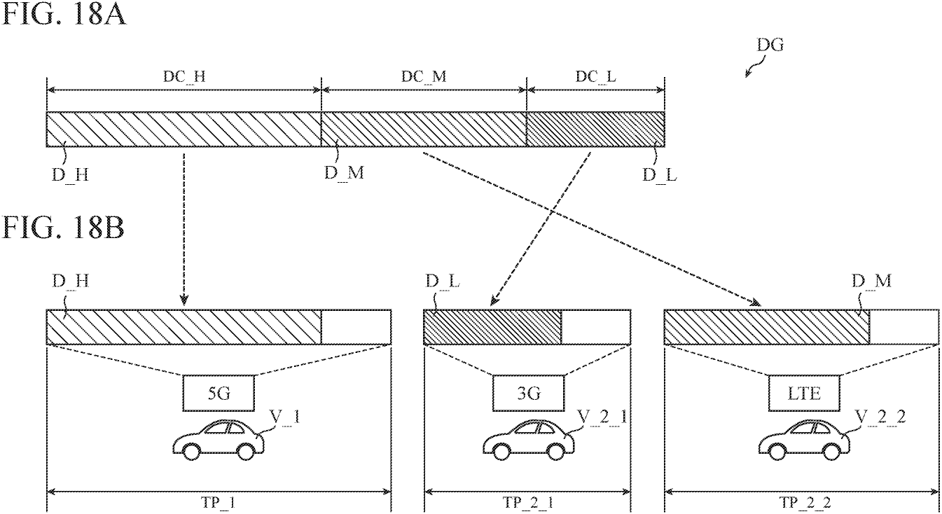

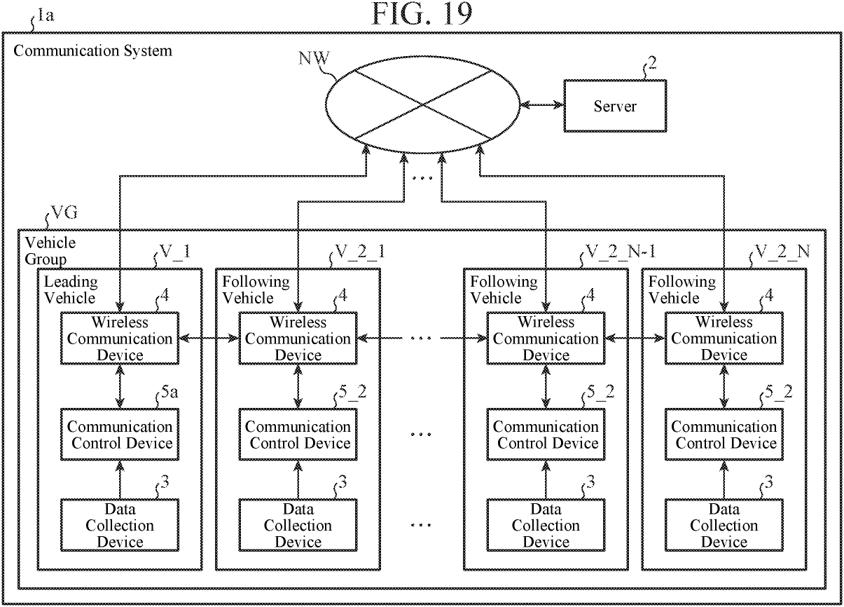

Here, a specific example of assignment by the data assignment unit 42 will be described with reference to FIG. 18. FIG. 18A illustrates an example of the data group DG to be transmitted to the server 2. The data group DG to be transmitted to the server 2 includes data D_H, D_M, and D_L. In FIG. 18A, the capacity DC required for each of the data D_H, D_M, and D_L is illustrated. A high priority P is given to the data D_H. A medium priority P is given to the data D_M. A low priority P is given to the data D_L.

On the other hand, FIG. 18B illustrates an example of a state in which the data D is assigned to the individual vehicles V. Now, the vehicle group VG includes three vehicles V_1, V_2_1, and V_2_2. In FIG. 18B, a communication standard in each of the vehicles V_1, V_2_1, and V_2_2 is illustrated, and a throughput TP in each of the vehicles V_1, V_2_1, and V_2_2 is illustrated. As illustrated in FIG. 18B, the vehicle V_1 corresponds to a high throughput TP_1. The vehicle V_2_1 corresponds to a low throughput TP_2_1. The vehicle V_2_2 corresponds to a medium throughput TP_2_2.

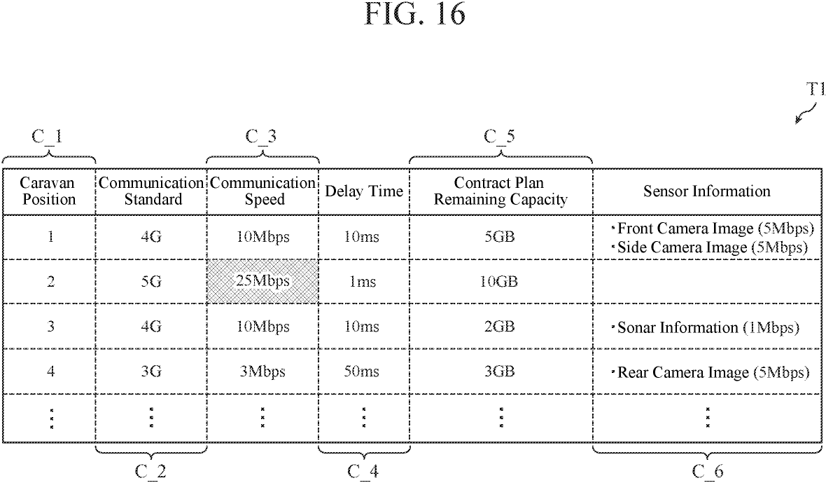

On the basis of the algorithm described with reference to FIG. 13, first, the data D_H corresponding to the high priority P is preferentially assigned to the vehicle V_1 corresponding to the high throughput TP_1. Next, the data D_M corresponding to the medium priority P is assigned to the vehicle V_2_2 corresponding to the medium throughput TP_2_2. Next, the data D_L corresponding to the low priority P is assigned to the vehicle V_2_1 corresponding to the low throughput TP_2_1. As a result, the state illustrated in FIG. 18B is achieved.

Next, effects of the communication system 1 will be described.

As described above, to each individual vehicle V, the data D to be transmitted by the vehicle to the server 2 is distributed in the communication system 1. Such distribution is based on a result of assignment using vehicle information including communication performance information. As a result, transmission of the data D depending on the performance of the wireless communication in each individual vehicle V can be implemented.

In particular, by using the algorithm described with reference to FIG. 13, the data D corresponding to the high priority P is preferentially assigned to the vehicle V corresponding to the high throughput depending on the purpose of the data group DG. As a result, it is possible to suppress the occurrence of a delay in the transmission of the data D. As a result, when the data group DG is used for an application having real-time properties (for example, remote driving or remote monitoring), such real-time properties can be achieved.

Next, modifications of the communication system 1 will be described.

The algorithm of the assignment by the data assignment unit 42 is not limited to that described with reference to FIG. 13. The data assignment unit 42 is only required to assign, depending on the performance of the wireless communication in each individual vehicle V, the data D to the vehicle V using the vehicle information including the communication performance information. The communication performance information is only required to include information used for assignment by the data assignment unit 42. For example, the communication performance information may be information including at least one of communication standard information, throughput information, delay time information, contract plan capacity information, or contract plan remaining capacity information.

The vehicle V in which the vehicle information acquiring processing and the data assignment processing are executed is not limited to the leading vehicle V_1. Further, the vehicle V in which the vehicle information output processing and the assignment information acquiring processing are executed is not limited to each individual following vehicle V_2. The vehicle information acquiring processing and the data assignment processing may be executed in any one vehicle V (hereinafter, may be referred to as a “representative vehicle”) among the N + 1 vehicles V, and the vehicle information output processing and the assignment information acquiring processing may be executed in each of the remaining N vehicles V among the N + 1 vehicles V.

For example, the communication control device 5 in each individual vehicle V may include the vehicle information acquiring unit 41, the data assignment unit 42, the vehicle information output unit 51, and the assignment information acquiring unit 52. Then, in the representative vehicle, the vehicle information acquiring function and the data assignment function may be turned on, and the vehicle information output function and the assignment information acquiring function may be turned off. On the other hand, in each of the remaining N vehicles V among the N + 1 vehicles V, the vehicle information acquiring function and the data assignment function may be turned off, and the vehicle information output function and the assignment information acquiring function may be turned on.

As described above, in the communication system 1 in which the plurality of vehicles V included in the vehicle group VG traveling in a caravan communicate freely with each other by wireless communication, and each of the plurality of vehicles V communicates freely with the server 2 by wireless communication, the communication control device 5 according to the first embodiment is provided in a representative vehicle among the plurality of vehicles V, and includes: the vehicle information acquiring unit 41 to acquire vehicle information including communication performance information indicating performance of the wireless communication in each of the plurality of vehicles V; the data assignment unit 42 to assign individual pieces of data D included in the data group DG collected by the vehicle group VG to respective selected vehicles V among the plurality of vehicles V on the basis of the performance of the wireless communication; the data distribution unit 43 to execute control to distribute a piece of data D included in the data group DG to a corresponding one of the plurality of vehicles V by wireless communication on the basis of a result of the assignment by the data assignment unit 42, and the transmission control unit 44 to execute control to transmit one of the pieces of data D which is assigned to the representative vehicle to the server 2 by wireless communication. As a result, transmission of the data D depending on the performance of the wireless communication in each individual vehicle V can be implemented.

In addition, the communication system 1 according to the first embodiment is a system in which the plurality of vehicles V included in the vehicle group VG traveling in a caravan communicate freely with each other by wireless communication, and each of the plurality of vehicles V communicates freely with the server 2 by wireless communication. The communication control device 5 is provided in the representative vehicle among the plurality of vehicles V, and includes: the vehicle information acquiring unit 41 to acquire vehicle information including communication performance information indicating performance of the wireless communication in each of the plurality of vehicles V; the data assignment unit 42 to assign individual pieces of data D included in the data group DG collected by the vehicle group VG to respective selected vehicles V among the plurality of vehicles V on the basis of the performance of the wireless communication; the data distribution unit 43 to execute control to distribute a piece of data D included in the data group DG to a corresponding one of the plurality of vehicles V by wireless communication on the basis of a result of the assignment by the data assignment unit 42; and the transmission control unit 44 to execute control to transmit one of the pieces of data D which is assigned to the representative vehicle to the server 2 by wireless communication. As a result, transmission of the data D depending on the performance of the wireless communication in each individual vehicle V can be implemented.

Further, the communication control method according to the first embodiment is executed in the representative vehicle among the plurality of vehicles V in the communication system 1 in which the plurality of vehicles V included in the vehicle group VG traveling in a caravan communicate freely with each other by wireless communication, and each of the plurality of vehicles V communicates freely with the server 2 by wireless communication. The method includes: step ST1 in which the vehicle information acquiring unit 41 acquires vehicle information including communication performance information indicating performance of the wireless communication in each of the plurality of vehicles V; step ST2 in which the data assignment unit 42 assigns individual pieces of data D included in the data group DG collected by the vehicle group VG to respective selected vehicles V among the plurality of vehicles V on the basis of the performance of the wireless communication; step ST3 in which the data distribution unit 43 distributes a piece of data included in the data group DG to a corresponding one of the plurality of vehicles V by wireless communication on the basis of a result of the assignment by the data assignment unit 42; and step ST4 in which the transmission control unit 44 executes control to transmit one of the pieces of data D which is assigned to the representative vehicle to the server 2 by wireless communication. As a result, transmission of the data D depending on the performance of the wireless communication in each individual vehicle V can be implemented.

### Second Embodiment

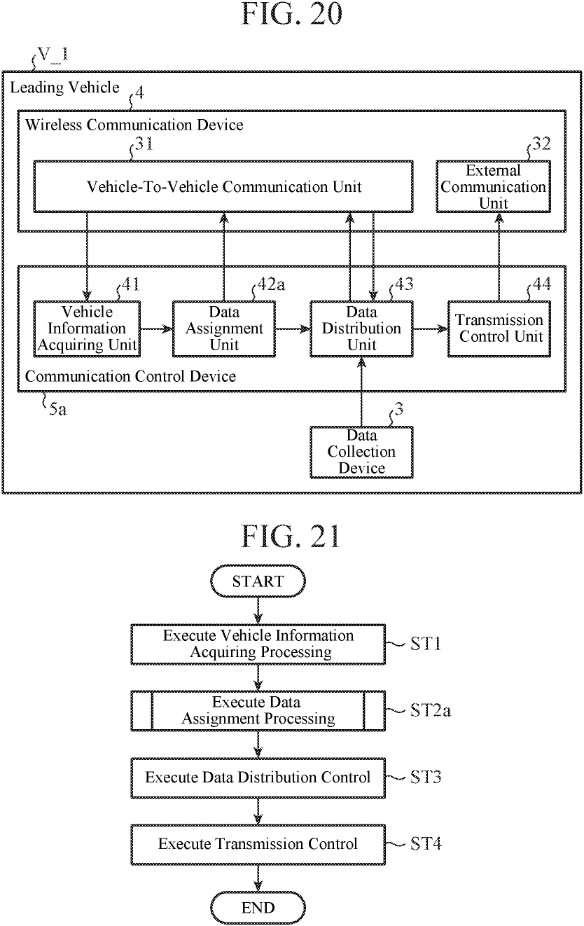

FIG. 19 is a block diagram illustrating a main part of a communication system according to a second embodiment. FIG. 20 is a block diagram illustrating a main part of a communication control device provided in a representative vehicle in the communication system according to the second embodiment. The communication system according to the second embodiment will be described with reference to FIGS. 19 and 20. In FIG. 19, the same reference numerals are given to the same blocks as those illustrated in FIG. 1, and the description thereof will be omitted. In FIG. 20, the same reference numerals are given to the same blocks as those illustrated in FIG. 5, and the description thereof will be omitted.

As illustrated in FIG. 19, a communication system 1a includes a server 2 and a vehicle group VG. A communication control device 5a is provided in a representative vehicle of the vehicle group VG. More specifically, the communication control device 5a is provided in the leading vehicle V_1. As illustrated in FIG. 20, the communication control device 5a includes a vehicle information acquiring unit 41, a data assignment unit 42a, a data distribution unit 43, and a transmission control unit 44.

The data assignment unit 42a assigns an individual piece of data D to the selected vehicle V by an assignment method similar to the assignment method used by the data assignment unit 42. That is, the data assignment unit 42a assigns the individual piece of data D to the selected vehicle V by an algorithm similar to the algorithm described with reference to FIG. 13.

Here, when the individual piece of data D is assigned to the selected vehicle V, the capacity required for the data D may be larger than the value of the throughput in the corresponding cell of the vehicle information table T1. In this case, the value of the throughput in the corresponding cell of the updated vehicle information table T1 is 0 Mbps or less. At this time, the data assignment unit 42a cancels the assignment of the data D. As a result, the data D is not assigned to any vehicle V. That is, the data D is unassigned.

In a case where there is such unassigned data D, the data assignment unit 42a divides each individual piece of data D. Then, the data assignment unit 42a assigns the divided data D to the selected vehicle V by an assignment method similar to the assignment method used by the data assignment unit 42.

As a result, the divided data D is assigned to the vehicle V in order from the data D corresponding to the higher priority P and in order from the vehicle V corresponding to the higher throughput.

Here, when the total amount of data D included in the data group DG is larger than the total amount of throughput in N + 1 vehicles, no matter which vehicle the piece of data D corresponding to the low priority P is assigned to, the value of the throughput in the corresponding cell of the updated vehicle information table T1 may be 0 Mbps or less. In this case, the data assignment unit 42a cancels the assignment of the data D. As a result, the data D is not assigned to any vehicle V. That is, the data D is unassigned.

In a case where there is such unassigned data D, the data assignment unit 42a excludes the unassigned data D from the assignment target. As a result, such unassigned data D is discarded by the data distribution control. That is, such unassigned data D is excluded from the transmission target to the server 2.

As a result, even when the total amount of data D included in the data group DG is larger than the total amount of throughput in N + 1 vehicles, the piece of data D with high priority P can be transmitted to the server 2 depending on the application which uses the data group DG. For example, when the application which uses the data group DG is remote driving, the data D_1_1 indicating the front camera image in the leading vehicle V_1 can be transmitted to the server 2.

Hereinafter, the processing executed by the data assignment unit 42a may be collectively referred to as “data assignment processing”. In addition, the functions of the data assignment unit 42a may be collectively referred to as a “data assignment function”. In addition, a reference sign “F2a” may be used for such a data assignment function.

The hardware configuration of the main part of the communication control device 5a is similar to that described with reference to FIGS. 7 to 9 in the first embodiment. Therefore, detailed description is omitted.

That is, the communication control device 5a has a plurality of functions (including a vehicle information acquiring function, a data assignment function, a data distribution function, and a transmission function) F1, F2a, F3, and F4. Each of the plurality of functions F1, F2a, F3, and F4 may be implemented by the processor 61 and the memory 62, or may be implemented by the processing circuit 63.

Here, the processor 61 may include a dedicated processor corresponding to each of the plurality of functions F1, F2a, F3, and F4. In addition, the memory 62 may include a dedicated memory corresponding to each of the plurality of functions F1, F2a, F3, and F4. In addition, the processing circuit 63 may include a dedicated processing circuit corresponding to each of the plurality of functions F1, F2a, F3, and F4.

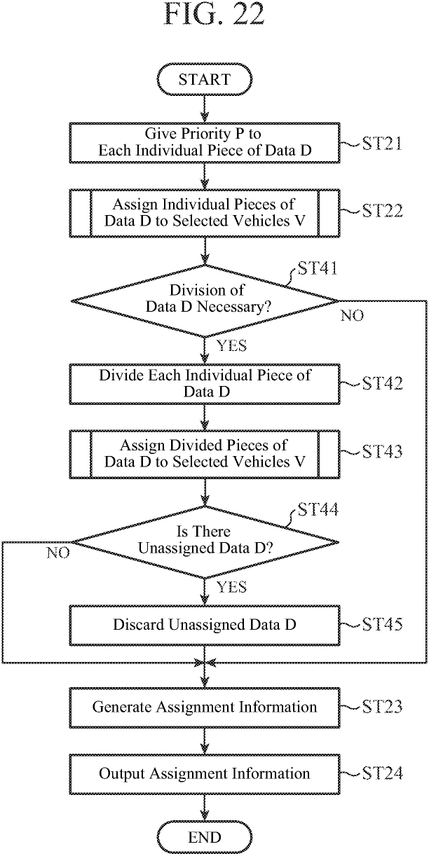

Next, the operation of the communication control device 5a will be described with reference to a flowchart illustrated in FIG. 21. Note that, in FIG. 21, steps similar to those illustrated in FIG. 10 are denoted by the same reference numerals.

First, the vehicle information acquiring unit 41 executes vehicle information acquiring processing (step ST1). Next, the data assignment unit 42a executes data assignment processing (step ST2a). Next, the data distribution unit 43 executes data distribution control (step ST3). Next, the transmission control unit 44 executes transmission control (step ST4).

Next, the operation of the data assignment unit 42a will be described with reference to a flowchart illustrated in FIG. 22. That is, the processing executed in step ST2a will be described. Note that, in FIG. 22, steps similar to those illustrated in FIG. 12 are denoted by the same reference numerals.

First, the data assignment unit 42a gives a priority P to each individual piece of data D included in the data group DG (step ST21). Next, the data assignment unit 42 assigns the individual pieces of data D included in the data group DG to the selected vehicles V among the plurality of vehicles V (step ST22).

Here, the data assignment unit 42a determines whether or not it is necessary to divide the data D (step ST41). As to at least one of the pieces of data D, when the value of the throughput in the corresponding cell of the vehicle information table T1 is 0 Mbps or less, the data assignment unit 42a determines that it is necessary to divide the data D (“YES” in step ST41). Next, the data assignment unit 42a divides each individual piece of data D (step ST42).

At this time, the data assignment unit 42a divides each individual piece of data D as follows using the vehicle information table T1. That is, the data assignment unit 42a divides each individual piece of data D in such a manner that at least the data D corresponding to the high priority P and the data D corresponding to the medium priority P among the divided data D are each assigned to one of the vehicles V.

Next, the data assignment unit 42a assigns the divided pieces of data D to the selected vehicles V among the plurality of vehicles V (step ST43). The assignment algorithm in step ST43 is similar to the assignment algorithm in step ST22. That is, the assignment algorithm in step ST43 is similar to that described with reference to FIG. 13. Therefore, detailed description is omitted.

Here, the data assignment unit 42a determines whether or not there is unassigned data D in step ST43 (step ST44). That is, as to the data D corresponding to the low priority P, when the value of the throughput in the corresponding cell of the vehicle information table T1 is 0 Mbps or less, the data D is unassigned (“YES” in step ST44). The data assignment unit 42a excludes the data D from the assignment target. As a result, the data D is discarded (step ST45).

Next, the data assignment unit 42a generates assignment information (step ST23). That is, in a case of “NO” in step ST41, the assignment information based on the assignment result in step ST22 is generated. On the other hand, in a case of “YES” in step ST42, the assignment information based on the assignment result in step ST43 is generated. In addition, in this case, when “YES” in step ST44, the assignment information from which one of the pieces of data D (that is, the piece of data D corresponding to the low priority P) is excluded is generated.

Next, the data assignment unit 42a outputs the generated assignment information (step ST24).

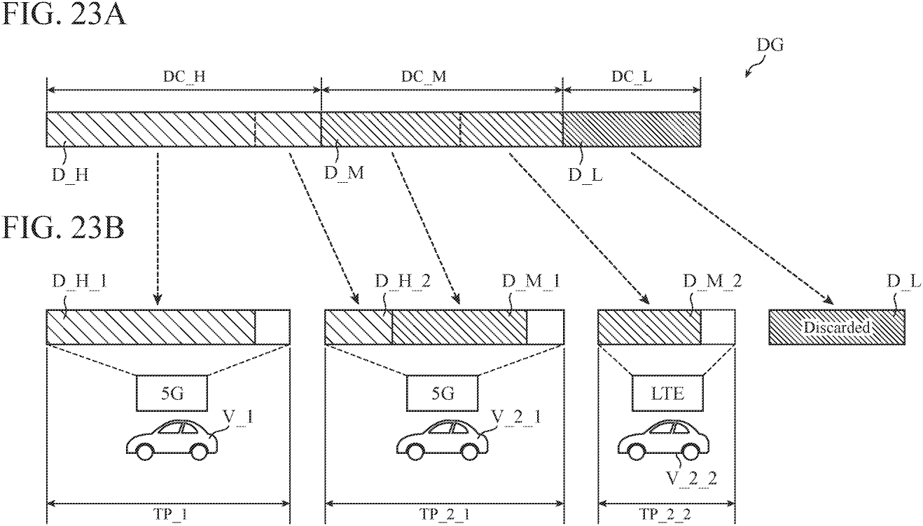

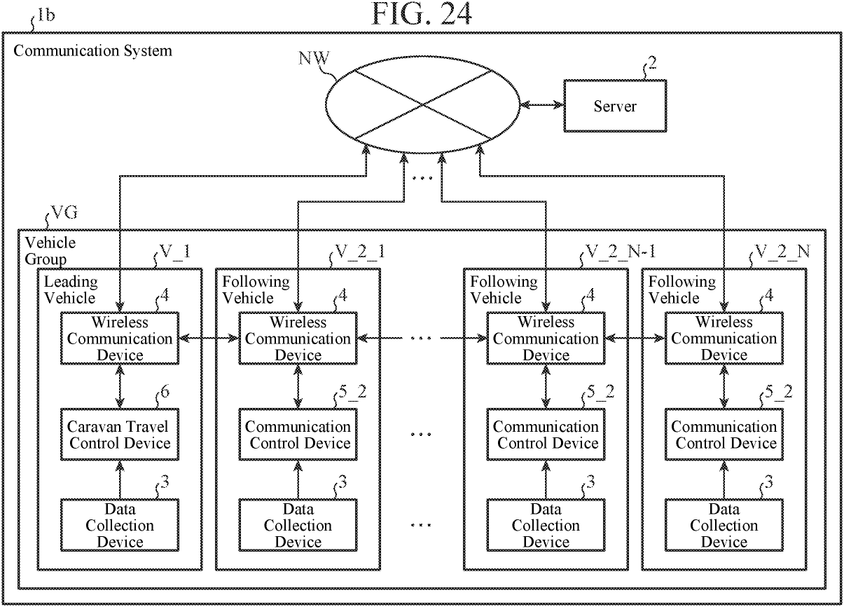

Next, a specific example of assignment by the data assignment unit 42a will be described with reference to FIG. 23.

FIG. 23A illustrates an example of the data group DG to be transmitted to the server 2. The data group DG to be transmitted to the server 2 includes data D_H, D_M, and D_L. In FIG. 23A, the capacity DC required for each of the data D_H, D_M, and D_L is illustrated. A high priority P is given to the data D_H. A medium priority P is given to the data D_M. A low priority P is given to the data D_L.

On the other hand, FIG. 23B illustrates an example of a state in which the data D is assigned to the individual vehicles V. Now, the vehicle group VG includes three vehicles V_1, V_2_1, and V_2_2. In FIG. 23B, a communication standard in each of the vehicles V_1, V_2_1, and V_2_2 is illustrated, and a throughput TP in each of the vehicles V_1, V_2_1, and V_2_2 is illustrated. As illustrated in FIG. 23B, the vehicle V_1 corresponds to a high throughput TP_1. The vehicle V_2_1 corresponds to a high throughput TP_2_1. The vehicle V_2_2 corresponds to a medium throughput TP_2_2.

In the example illustrated in FIG. 23, the capacity DC_H required for the data D_H is larger than the throughput TP_1, and the capacity DC_H required for the data D_H is larger than the throughput TP_2_1. Therefore, the data D_H is not assigned in step ST22, and thus step ST41 is “YES”. As a result, the data D is divided (step ST42) .

At this time, each of the data D_H and D_M is divided as follows using the vehicle information table T1. That is, first, the data D_H is divided into data D_H_1 and D_H_2 in such a manner that the capacity required for the data D_H_1 becomes smaller than the throughput TP_1. Next, the data DM is divided into data D_M_1 and D_M_2 in such a manner that the total capacity required for the data D_H_2 and D_M_1 becomes smaller than the throughput TP_2_1.

Next, the divided data D is assigned to the vehicles V in descending order of the priority P and in descending order of the throughput TP. That is, first, the data D_H_1 is assigned to the vehicle V_1, and the data D_H_2 is assigned to the vehicle V_2_1. Next, the data D_M_1 is assigned to the vehicle V_2_1, and the data D_M_2 is assigned to the vehicle V_2_2.

At this time, the data D_L cannot be assigned to any vehicle V due to the shortage of the throughput TP. Therefore, step ST44 is “YES”. The data D_L is excluded from the assignment target (step ST45). As a result, the data D_L is discarded.

Note that the communication system 1a can adopt various modifications similar to those described in the first embodiment.

As described above, in the communication control device 5a according to the second embodiment, the data assignment unit 42a divides the individual pieces of data D on the basis of the performance of the wireless communication, and includes the divided pieces of data D in the assignment targets. As a result, for example, even when the capacity required for an individual piece of data D is larger than the throughput in the selected vehicle V, the data D can be transmitted to the server 2.

### Third Embodiment

FIG. 24 is a block diagram illustrating a main part of a communication system according to a third embodiment. FIG. 25 is a block diagram illustrating a main part of a caravan travel control device in the communication system according to the third embodiment. The communication system according to the third embodiment will be described with reference to FIGS. 24 and 25. In FIG. 24, the same reference numerals are given to the same blocks as those illustrated in FIG. 1, and the description thereof will be omitted. In FIG. 25, the same reference numerals are given to the same blocks as those illustrated in FIG. 5, and the description thereof will be omitted.

As illustrated in FIG. 24, a communication system 1b includes a server 2 and a vehicle group VG. A caravan travel control device 6 is provided in a representative vehicle of the vehicle group VG. More specifically, the caravan travel control device 6 is provided in the leading vehicle V_1. As illustrated in FIG. 25, the caravan travel control device 6 includes a communication control device 5_1 and a vehicle order changing unit 71.

When executing the data assignment processing, the data assignment unit 42 outputs the assignment information to the vehicle order changing unit 71.

The vehicle order changing unit 71 determines whether or not it is necessary to change the order (hereinafter, may be referred to as a “vehicle order”) of the plurality of vehicles V in the vehicle group VG, using the communication performance information (more specifically, throughput information) included in the vehicle information acquired by the vehicle information acquiring unit 41 and the assignment information output by the data assignment unit 42. When it is determined that it is necessary to change the vehicle order, the vehicle order changing unit 71 executes control to change the vehicle order. Such control uses vehicle-to-vehicle communication. A specific example of the method of determining whether or not it is necessary to change the vehicle order will be described later with reference to FIGS. 30 to 32.

In a case where it is determined that it is necessary to change the vehicle order, the data assignment unit 42 outputs the assignment information to the vehicle-to-vehicle communication unit 31 and the data distribution unit 43 when the change of the vehicle order is completed. As a result, the assignment information acquiring processing in each of the following vehicles V_2, the data distribution control in each of the vehicles V, and the data transmission control in each of the vehicles V are executed after the change of the vehicle order is completed.

Hereinafter, the processing and control executed by the vehicle order changing unit 71 may be collectively referred to as “vehicle order changing control”. The functions of the vehicle order changing unit 71 may be collectively referred to as a “vehicle order changing function”. In addition, a reference sign “F11” may be used for the vehicle order changing function.

The hardware configuration of the main part of the caravan travel control device 6 is similar to that described with reference to FIGS. 7 to 9 in the first embodiment. Therefore, detailed description is omitted.

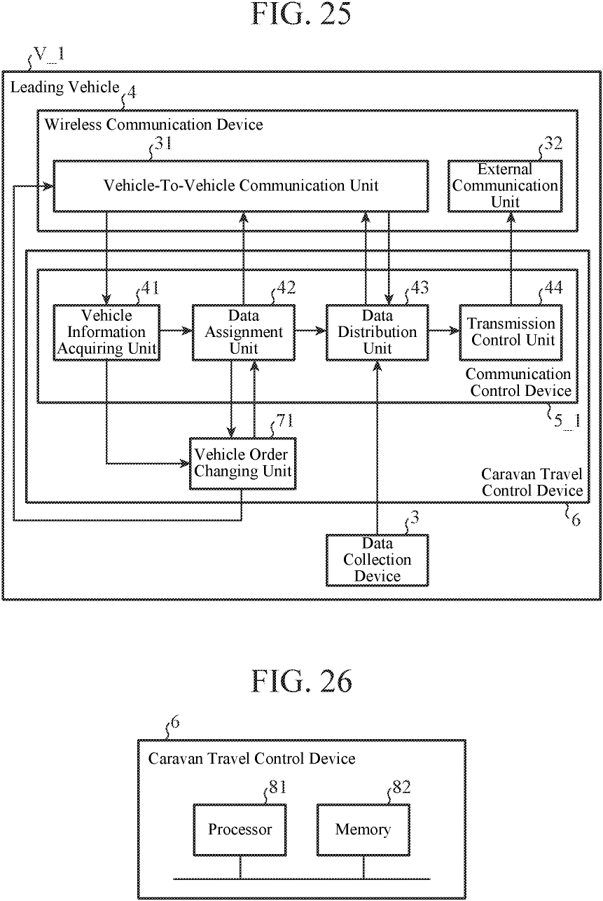

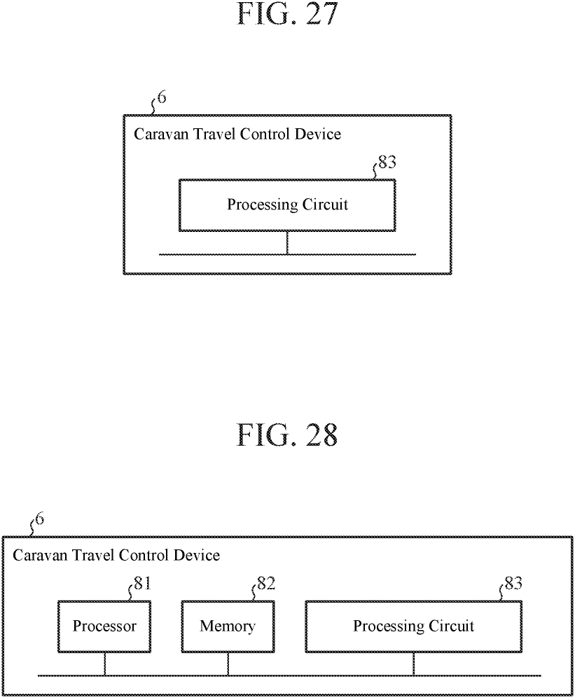

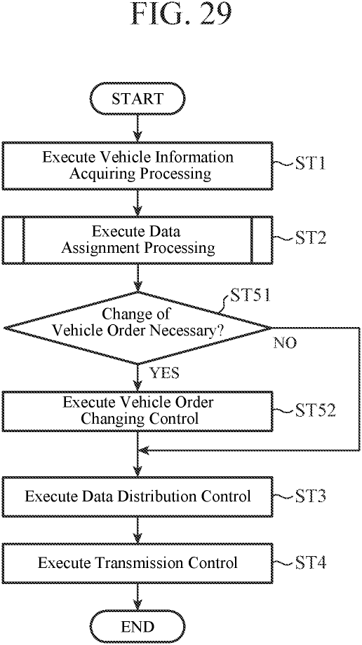

That is, the caravan travel control device 6 has a plurality of functions (including a vehicle information acquiring function, a data assignment function, a vehicle order changing function, a data distribution function, and a transmission function) F1 to F4 and F11. Each of the plurality of functions F1 to F4 and F11 may be implemented by a processor 81 and a memory 82, or may be implemented by a processing circuit 83 (See FIG. 26, FIG. 27, or FIG. 28).

Here, the processor 81 may include a dedicated processor corresponding to each of the plurality of functions F1 to F4 and F11. In addition, the memory 82 may include a dedicated memory corresponding to each of the plurality of functions F1 to F4 and F11. In addition, the processing circuit 83 may include a dedicated processing circuit corresponding to each of the plurality of functions F1 to F4 and F11.

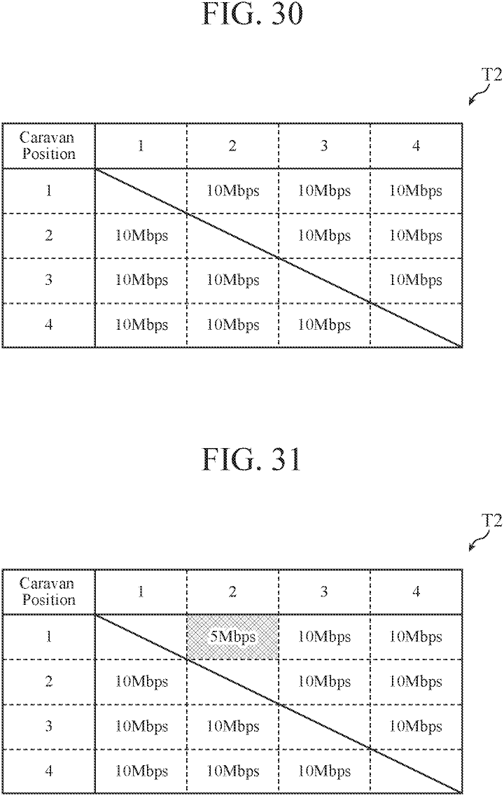

Next, the operation of the caravan travel control device 6 will be described with reference to a flowchart illustrated in FIG. 29. Note that, in FIG. 29, steps similar to the steps illustrated in FIG. 10 are denoted by the same reference numerals, and description thereof is omitted.

First, the vehicle information acquiring unit 41 executes vehicle information acquiring processing (step ST1). Next, the data assignment unit 42 executes data assignment processing (step ST2).

Next, the vehicle order changing unit 71 determines whether or not it is necessary to change the vehicle order (step ST51). When it is determined that it is necessary to change the vehicle order (“YES” in step ST51), the vehicle order changing unit 71 executes the vehicle order changing control (step ST52). On the other hand, when it is determined that it is not necessary to change the vehicle order (“NO” in step ST51), the vehicle order changing unit 71 does not execute the vehicle order changing control.

Next, the data distribution unit 43 executes data distribution control (step ST3). Next, the transmission control unit 44 executes transmission control (step ST4).

Next, a specific example of a method of determining whether or not it is necessary to change the vehicle order will be described with reference to FIGS. 30 to 32. A specific example of changing the vehicle order will be described.

First, the vehicle order changing unit 71 generates a table (hereinafter, referred to as an “vehicle-to-vehicle communication throughput table”) T2 indicating a throughput (hereinafter, may be referred to as a “vehicle-to-vehicle communication throughput”) of the vehicle-to-vehicle communication between each pair of vehicles V among the N + 1 vehicles V, by using the throughput information in the communication performance information included in the vehicle information acquired by the vehicle information acquiring unit 41. FIG. 30 illustrates an example of the vehicle-to-vehicle communication throughput table T2.

Here, the assignment information output by the data assignment unit 42 includes information indicating the priority P given to each individual piece of data D (see FIG. 17). In addition, information indicating the capacity required for each individual piece of data D is included (see FIG. 17). Also, for each individual piece of data D, information indicating a route of vehicle-to-vehicle communication in the data distribution control is included (see FIG. 17).

Therefore, the vehicle order changing unit 71 determines whether or not the vehicle-to-vehicle communication throughput is sufficient, using the assignment information output by the data assignment unit 42. In other words, the vehicle order changing unit 71 determines whether or not there is a shortage of the vehicle-to-vehicle communication throughput.

That is, the vehicle order changing unit 71 updates the vehicle-to-vehicle communication throughput table T2 by subtracting the value indicating the capacity required for each individual piece of data D from the value of the throughput in the corresponding cell of the vehicle-to-vehicle communication throughput table T2. FIG. 31 illustrates an example of the updated vehicle-to-vehicle communication throughput table T2. In the examples illustrated in FIGS. 30 and 31, by subtracting the capacity (5 Mbps) required for the data D indicating the front camera image from the throughput (10 Mbps) of the vehicle-to-vehicle communication corresponding to “position 1 → position 2”, the value of the throughput is updated (10 Mbps -5 Mbps = 5 Mbps).

The vehicle order changing unit 71 executes such subtraction for all the pieces of data D. As a result, when the value of the throughput in at least one cell becomes 0 Mbps or less, the vehicle order changing unit 71 determines that the vehicle-to-vehicle communication throughput is not sufficient. That is, the vehicle order changing unit 71 determines that there is a shortage of the vehicle-to-vehicle communication throughput.

In this case, the vehicle order changing unit 71 determines that it is necessary to change the vehicle order, and executes control to change the vehicle order in such a manner that the vehicle-to-vehicle communication throughput becomes a sufficient value. At this time, on the basis of the priority P given to each individual piece of data D, the vehicle order is changed in such a manner that the vehicle-to-vehicle communication throughput becomes a sufficient value preferentially in order from the data D corresponding to the higher priority P.

When the change of the vehicle order is completed, the data assignment unit 42 outputs the assignment information to the vehicle-to-vehicle communication unit 31 and the data distribution unit 43. At this time, the data assignment unit 42 may partially correct the assignment information and output the corrected assignment information. That is, the data assignment unit 42 may correct the information indicating the route of the vehicle-to-vehicle communication in the data distribution control on the basis of the change in the vehicle order.

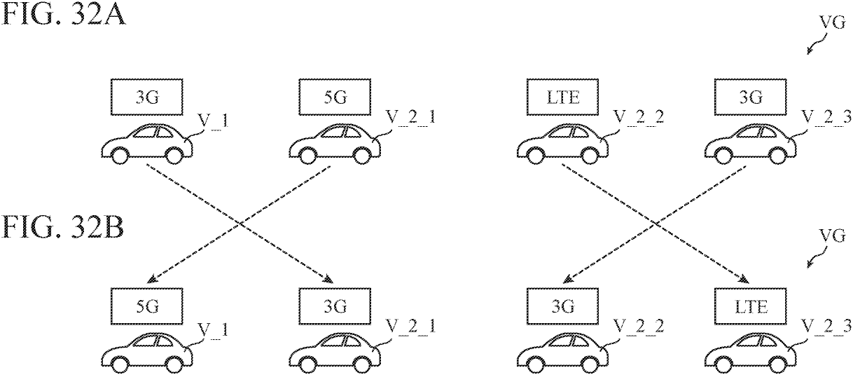

Here, a specific example of changing the vehicle order will be described with reference to FIG. 32. As illustrated in FIG. 32, the vehicle group VG includes four vehicles V_1, V_2_1, V_2_2, and V_2_3. In FIG. 32, communication standards in the vehicles V_1, V_2_1, V_2_2, and V_2_3 are illustrated.

The application which uses the data group DG is remote driving. Therefore, high priority P is given to data D_1_1 indicating the front camera image in the leading vehicle V_1 and data D_1_2 indicating the side camera image in the leading vehicle V_1. Then, high priority P is given to data D_1_3 indicating the rear camera image in the rearmost vehicle V_2_3.

FIG. 32A illustrates a state before the vehicle order is changed. In this case, the data D_1_1 and D_1_2 are preferably transmitted to the server 2 by the vehicle V_2_1 corresponding to the highest throughput (that is, the vehicle V_2_1 corresponding to the latest communication standard “5G”). In addition, the data D_1_3 is preferably transmitted to the server 2 by the vehicle V_2_2 corresponding to the next highest throughput (that is, the vehicle V_2_2 corresponding to the next latest communication standard “LTE”).

However, in this case, when the total capacity required for the data D_1_1 and D_1_2 is larger than the throughput of the vehicle-to-vehicle communication from the vehicle V_1 to the vehicle V_2_1, a delay may occur in the transmission of the data D_1_1 and D_1_2 in the data distribution control. In addition, when the capacity required for the data D_1_3 is larger than the throughput of the vehicle-to-vehicle communication from the vehicle V_2_3 to the vehicle V_2_2, a delay may occur in the transmission of the data D_1_3 in the data distribution control.

On the other hand, FIG. 32B illustrates a state after the vehicle order is changed. That is, as illustrated in FIG. 32, the vehicle order changing unit 71 executes control to exchange the vehicles V_1 and V_2_1 and executes control to exchange the vehicles V_2_2 and V_2_3. After the change of the vehicle order, the data D_1_1 and D_1_2 are preferably transmitted to the server 2 by the leading vehicle V_1. The data D_1_3 is preferably transmitted to the server 2 by the rearmost vehicle V_2_3.

That is, after the change of the vehicle order, distribution by vehicle-to-vehicle communication is unnecessary for the data D_1_1, D_1_2, and D_1_3 corresponding to the high priority P. As a result, even when the vehicle-to-vehicle communication throughput is low, it is possible to suppress the occurrence of the delay.

Note that the communication system 1b can adopt various modifications similar to those described in the first embodiment.

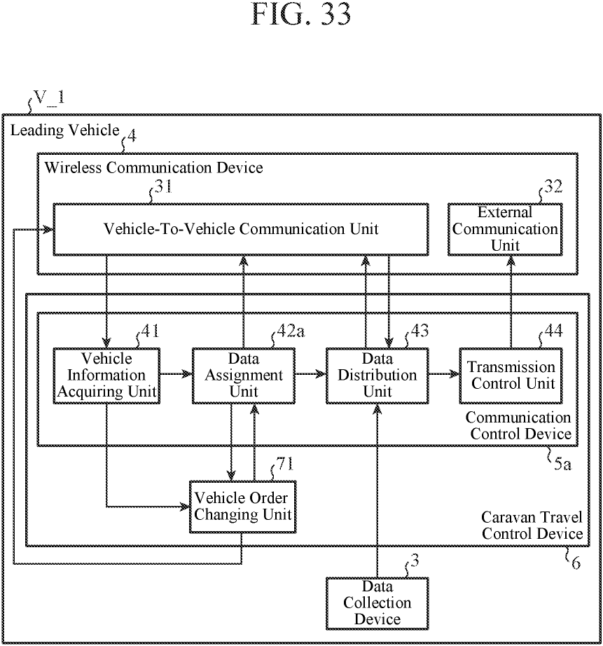

As illustrated in FIG. 33, the caravan travel control device 6 may include a communication control device 5a instead of the communication control device 5_1. That is, the caravan travel control device 6 may include a data assignment unit 42a instead of the data assignment unit 42.

The method of changing the vehicle order by the vehicle order changing unit 71 is not limited to the above specific example. The vehicle order changing unit 71 is only required to change, depending on the performance of the wireless communication in each individual vehicle V (more specifically, depending on the performance of the vehicle-to-vehicle communication), the vehicle order using the vehicle information including the communication performance information. As a result, it is possible to implement the change of the vehicle order depending on the performance of the wireless communication (more specifically, the performance of the vehicle-to-vehicle communication) in each individual vehicle V.

Furthermore, in the communication system 1b, the vehicle order can be changed. Therefore, the caravan travel control device 6 including the communication control device 5 or the communication control device 5a may be provided in each individual vehicle V.

As described above, the caravan travel control device 6 according to the third embodiment includes the communication control device 5 or the communication control device 5a, and the vehicle order changing unit 71 that executes control to change the order (vehicle order) of the plurality of vehicles V in the vehicle group VG on the basis of the performance of the wireless communication. As a result, it is possible to change the vehicle order depending on the performance of the wireless communication in each individual vehicle V. As a result, for example, even in a case where the vehicle-to-vehicle communication throughput is low, the occurrence of the delay can be suppressed.

Note that, within the scope of the disclosure of the present application, the embodiments can be freely combined, any component in each embodiment can be modified, or any component in each embodiment can be omitted.

### INDUSTRIAL APPLICABILITY

The communication control device, the caravan travel control device, the communication system, and the communication control method according to the present disclosure can be used for a vehicle group traveling in a caravan.

### REFERENCE SIGNS LIST

1, 1a, 1b: communication system, 2: server, 3: data collection device, 4: wireless communication device, 5, 5a: communication control device, 6: caravan travel control device, 11: sensor, 11_1: camera, 11_1_1: front camera, 11_1_2: side camera, 11_1_3: rear camera, 11_2: sonar, 11_3: LiDAR, 11_4: GNSS receiver, 21: transmitter, 22: receiver, 31: vehicle-to-vehicle communication unit, 32: external communication unit, 41: vehicle information acquiring unit, 42, 42a: data assignment unit, 43: data distribution unit, 44: transmission control unit, 51: vehicle information output unit, 52: assignment information acquiring unit, 53: data distribution unit, 54: transmission control unit, 61: processor, 62: memory, 63: processing circuit, 71: vehicle order changing unit, 81: processor, 82: memory, 83: processing circuit, NW: network, V: vehicle, V_1: vehicle (leading vehicle), V_2: vehicle (following vehicle), VG: vehicle group

1. A communication control device provided in a representative vehicle among a plurality of vehicles in a communication system in which the plurality of vehicles included in a vehicle group traveling in a caravan communicate freely with each other by wireless communication, and each of the plurality of vehicles communicates freely with a server by the wireless communication, the communication control device comprising:
processing circuitry
to acquire vehicle information including communication performance information indicating performance of the wireless communication in each of the plurality of vehicles;
to assign individual pieces of data included in a data group collected by the vehicle group to respective selected vehicles among the plurality of vehicles on a basis of the performance of the wireless communication;
to execute control to distribute a piece of data included in the data group to a corresponding one of the plurality of vehicles by the wireless communication on a basis of a result of the assignment; and
controller to execute control to transmit one of the pieces of data which is assigned to the representative vehicle to the server by the wireless communication.

2. The communication control device according to claim 1, wherein the processing circuitrygives a priority to each of the individual pieces of data and assigns the individual pieces of data to the respective selected vehicles on a basis of the priority.

3. The communication control device according to claim 2, wherein the processing circuitry gives the priority which varies depending on a purpose of the data group to each of the individual pieces of data.

4. The communication control device according to claim 1, wherein the communication performance information includes at least one of information indicating a communication standard, information indicating a communication speed, information indicating a delay time, information indicating a contract plan capacity, or information indicating a contract plan remaining capacity.

5. The communication control device according to claim 1, wherein the processing circuitrydivides the individual pieces of data on a basis of the performance of the wireless communication and includes the divided pieces of data in targets of the assignment.

6. A caravan travel control device comprising:
the communication control device according to claim 1,
wherein the processing circuitry executes control to change an order of the plurality of vehicles in the vehicle group on a basis of the performance of the wireless communication.

7. A communication system in which a plurality of vehicles included in a vehicle group traveling in a caravan communicate freely with each other by wireless communication, and each of the plurality of vehicles communicates freely with a server by the wireless communication, wherein
a communication control device is provided in a representative vehicle among the plurality of vehicles, and
the communication control device includes:
processing circuitry
to acquire vehicle information including communication performance information indicating performance of the wireless communication in each of the plurality of vehicles;
to assign individual pieces of data included in a data group collected by the vehicle group to respective selected vehicles among the plurality of vehicles on a basis of the performance of the wireless communication;
to execute control to distribute a piece of data included in the data group to a corresponding one of the plurality of vehicles by the wireless communication on a basis of a result of the assignment; and
to execute control to transmit one of the pieces of data which is assigned to the representative vehicle to the server by the wireless communication.

8. A communication control method executed in a representative vehicle among a plurality of vehicles in a communication system in which the plurality of vehicles included in a vehicle group traveling in a caravan communicate freely with each other by wireless communication, and each of the plurality of vehicles communicates freely with a server by the wireless communication, the communication control method comprising:
acquiring vehicle information including communication performance information indicating performance of the wireless communication in each of the plurality of vehicles;
assigningindividual pieces of data included in a data group collected by the vehicle group to respective selected vehicles among the plurality of vehicles on a basis of the performance of the wireless communication;
executing control to distribute a piece of data included in the data group to a corresponding one of the plurality of vehicles by the wireless communication on a basis of a result of the assignment; and
executing control to transmit one of the pieces of data which is assigned to the representative vehicle to the server by the wireless communication.
